(19) United States
(12) Patent Application Publication
(10) Pub. No.: US 2020/0402163 A1
(43) Pub. Date: Dec. 24, 2020

(54) METHOD FOR OPTIMIZING CREDIT RATING INDICATOR GROUP BASED ON THE MAXIMUM DEFAULT IDENTIFICATION ABILITY MEASURED BY FISHER SCORE

(71) Applicant: DALIAN UNIVERSITY OF TECHNOLOGY, Dalian, Liaoning (CN)

(72) Inventors: Guotai CHI, Dalian, Liaoning (CN); Shanli YU, Dalian, Liaoning (CN); Ying ZHOU, Dalian, Liaoning (CN)

(21) Appl. No.: 16/961,135

(22) PCT Filed: Jan. 22, 2018
(86) PCT No.: PCT/CN2018/073567

§ 371 Date: Jul. 9, 2020

(51) Int. Cl. G06Q 40/02; G06Q 10/04; G06F 17/18

(52) U.S. Cl. CPC G06Q 40/025; G06F 17/18; G06Q 10/04

(57) ABSTRACT

A method for optimizing a credit rating indicator group based on the maximum default identification ability measured by Fisher Score is disclosed. The maximum default identification ability measured by Fisher Score of the credit score is used as the standard for optimizing an indicator group. After the indicators reflecting information redundancy are removed, the Fisher Score values of all the indicator groups formed are compared by the traversing method, and the group of indicators with the maximum Fisher Score value of the default identification ability of the credit score is selected as the optimal indicator group. The method of the invention ensures the maximum overall default identification ability measured by Fisher Score of the credit rating system, and provides a decision basis for all investors such as banks and individuals to effectively identify credit risks.

### TECHNICAL FIELD

The present invention provides a method for selecting an optimal indicator group of credit rating, particularly relates to a method for optimizing a credit rating indicator group based on the maximum default identification ability measured by Fisher Score to maximize the default identification ability (Fisher Score) of a credit rating system, and belongs to the technical field of credit service.

### BACKGROUND

Credit is a lending activity on condition of repaying principal and interest. Credit rating aims to evaluate the credit level and the corresponding default probability of a customer through the value of credit rating indicators and default status.

Credit rating and its corresponding default probabilities are the basis for financial asset pricing. Errors in rating results may mislead individuals, enterprises, banks and other investors in their investment behavior, and even cause disorder of the whole financial system. One of the reasons for the financial crisis in 2008 was the rating failure of subprime loans.

The most basic key technology for credit rating is the selection of the optimal credit rating indicator system (indicator group). If the indicator system is unreasonable, it is impossible to obtain a reasonable rating result regardless of the value of the indicator weight and the form of the rating equation. Therefore, the construction of a credit rating indicator system is particularly important.

The representative patent research on the construction of the existing credit rating indicator system is mainly divided into two categories:

The first category is determination by qualitative analysis. “A device for evaluating the credit risk of a P2P on-line loan borrower” with the patent No. of 201710361864.X of the National Intellectual Property Administration, PRC determines credit rating indicators such as lending rate and education of a P2P on-line loan borrower through qualitative analysis. “A power credit rating method based on big data” with the patent No. of 201611159231.2 of the National Intellectual Property Administration, PRC determines power credit rating indicators such as electricity consumption behavior and payment behavior through qualitative analysis. “System and method for predicting consumer credit risk using income risk based credit score” with the U.S. Pat. No. 8,799,150 B2 of the United States Patent and Trademark Office determines age, education, income and the like as credit risk elements of a consumer through qualitative analysis.

The second category is determination by quantitative analysis. “A method and system for credit scoring of a bank customer” with the patent No. of 200310110722.4 of the National Intellectual Property Administration, PRC deletes an indicator with insignificant regression coefficient every time by establishing a multiple linear regression equation of indicator and default status, and the indicator in the equation is the preserved indicator until all regression equations and all partial regression coefficients are significant. “An electronic commerce credit rating method for dangerous chemicals” with the patent No. of 200610029720.6 of the National Intellectual Property Administration, PRC deletes the closely related indicators through independence analysis, and determines the credit rating indicators through principal component analysis.

The above qualitatively analyzed patents do not reflect the relationship between the credit rating indicator and the default identification ability, so it is impossible to select reasonable indicator.

The above patent technology for quantitative selection of indicators deletes individual indicators in sequence and thus cannot ensure that the remaining indicator groups have the maximum default identification ability. The reason is that the default identification ability of single indicator is poor and the group composed of single indicators is not necessarily poor; similarly, the default identification ability of single indicator is strong and the group composed of individual indicators is not necessarily strong.

The present invention uses Fisher Score of the credit score to measure the default identification ability of indicator system (rather than single indicator) and uses the maximum Fisher Score of the credit score as the standard for selecting an indicator group. After the indicators reflecting information redundancy are removed, the Fisher Score values of all the indicator groups formed are compared by the traversing method, and the group of indicators with the maximum Fisher Score value of the credit score is selected as the optimal indicator group to ensure that the final indicator group can distinguish default customers from non-default customers to the maximum extent. The optimal indicator group is also the final credit rating indicator system.

### SUMMARY

The purpose of the invention is to provide a method for optimizing a credit rating indicator group to maximize the default identification ability of credit score.

The technical solution of the present invention is:

With the idea that the lower the intra-group dispersion degree of credit scores of default customers and non-default customers is, the higher the inter-group dispersion degree is, and the more the credit score can distinguish default customers from non-default customers, the Fisher Score value is used to measure the default identification ability of the credit score. The maximum default identification ability measured by Fisher Score of credit score is used as the standard for optimizing an indicator group. After the indicators reflecting information redundancy are removed, the Fisher Score values of credit scores of different indicator groups formed are compared by the traversing method, and we select the indicator group with the maximum Fisher Score value of the credit score as the indicator system.

A method for optimizing credit rating indicator group based on the maximum default identification ability measured by Fisher Score comprises the following steps:

Step 1: loading data

Loading the source data of n samples for credit rating, mass-selection credit rating indicators and default status (default=1, non-default=0) indicators into an Excel file;

Step 2: preprocessing the data

Standardizing the source data of the mass-selection credit rating indicators by the Max-Min standardization method to eliminate the influence of indicator dimension;

Step 3: calculating the default identification ability Fᵢ of single mass-selection credit rating indicator

Measuring the default identification ability of the indicator by the Fisher Score; the larger the Fisher Score value of the indicator is, the lower the intra-group numerical dispersion degree of default customers and non-default customers is, the higher the inter-group dispersion degree is, and the more the indicator can significantly distinguish the default customers from the non-default customers; and the formula of the Fisher Score value of the indicator xᵢ is as follows:

$${F}_{i} = \frac{{( {\overline{x}}_{i}^{( 0 )} - \overline{{x}_{i}} )}^{2} + {( {\overline{x}}_{i}^{( 1 )} - \overline{{x}_{i}} )}^{2}}{\frac{1}{{n}_{0}} {\sum }_{{ }^{j = 1}}^{{n}_{0}} {( {x}_{ij}^{( 0 )} - {\overline{x}}_{i}^{( 0 )} )}^{2} + \frac{1}{{n}_{1}} {\sum }_{h = 1}^{{n}_{1}} {( {x}_{ih}^{( 1 )} - {\overline{x}}_{i}^{( 1 )} )}^{2}} \qquad ( 1 )$$

In formula (1), Fᵢ is the Fisher Score value of the i^{th} indicator, wherein i=1, 2, . . . ; xᵢ⁻⁽⁰⁾ is the average value of non-default customers under the i^{th} indicator; xᵢ⁻⁽¹⁾ is the average value of default customers under the i^{th} indicator; x̅ᵢ is the average value of customers under the i^{th} indicator; xᵢⱼ⁽⁰⁾ is the value of the j^{th} non-default customer under the i^{th} indicator; xᵢₕ⁽¹⁾ is the value of the h^{th} default customer under the i^{th} indicator; n₀ is the number of non-default customers; and n₁ is the number of default customers;

Step 4: deleting the indicators reflecting information redundancy to form the first indicator group ψ₁(M)

Determining the indicator pair reflecting information redundancy through correlation analysis, deleting the indicator with the minimum Fisher Score value in the indicator pair reflecting information redundancy, and forming the first indicator group ψ₁(M) by the remaining M non-redundant indicators;

Several methods are provided to delete the indicators reflecting information redundancy;

Step 5: giving a weight wᵢ(m) to the credit rating indicator

Weighting the indicator by the formula

$${w}_{i} ( m ) = {F}_{i} / {\sum }_{i = 1}^{m} {F}_{i} ,$$

and ensuring that the larger the Fisher Score value of the indicator is, the larger the weight is;

Wherein wᵢ(m) is the weight of the i^{th} indicator in the indicator group ψ(m); and m is the number of indicators to be weighted in the indicator group ψ(m), wherein m=1, 2, . . . , M;

Step 6: calculating credit cores Sⱼ(m) of the customers

Solving the credit score of the customer j by the linear weighting formula

$${S}_{j} ( m ) = {\sum }_{i = 1}^{m} {w}_{i} ( m ) \times {x}_{ij} ,$$

wherein xᵢⱼ is the value of the j^{th} customer under the i^{th} indicator;

Step 7: calculating the default identification ability F₁(M) of the credit score Sⱼ(M) of the customer based on the indicator group ψ₁(M)

Substituting the credit score Sⱼ(m)=Sⱼ(M) of step 6 for the indicator data xᵢ into formula (1) to obtain the default identification ability F₁(M) of the credit score Sⱼ(M), i.e., the default identification ability F₁(M) of the indicator group ψ₁(M);

This is different from step 3 in which the default identification ability measured by Fisher Score of single indicator is calculated, and step 7 to step 9 starting therefrom are to calculate the default identification ability measured by Fisher Score of the indicator group;

Step 8: determining the second indicator group ψ₂(M−1) and the default identification ability F₂(M−1) thereof

Removing one indicator on the basis of M indicators of the first indicator group of step 4 to form the indicator groups ψ₂(M−1) of M−1 indicators; and the number of the indicator groups ψ₂(M−1) is M because all the 1^{st} indicator, the 2^{nd} indicator and the M^{th} indicator can be removed;

According to step 5 to step 7, testing the Fisher Score values F₂(M−1) of the M indicator groups ψ₂(M−1), and selecting the indicator group with the maximum Fisher Score and the maximum corresponding default identification ability measured by Fisher Score as the selection result of step 8 and the basis for next selection;

Step 9: determining other indicator groups and the default identification abilities thereof

Removing one indicator on the basis of the indicator group with the maximum Fisher Score selected in step 8 to obtain the indicator groups ψ₃(M−2) formed by M−2 indicators; this is similar to step 8 in that the number of the groups ψ₃(M−2) of M−2 indicators is M−1 in total; and according to step 8, testing the Fisher Score values F₃(M−2) of the M−1 indicator groups ψ₃(M−2) to obtain the indicator group with the maximum Fisher Score and the maximum corresponding default identification ability measured by Fisher Score;

F₄(M−3), F₅(M−4), . . . , F_{M}(1) are obtained in the same manner;

Step 10: determining the optimal indicator group

In step 4 to step 9, selecting the indicator group ψᵢ(M+1−i) corresponding to the maximum value Fᵢ(M+1−i) from F₁(M), F₂(M−1), F₃(M−2), . . . , F_{M}(1) as the optimal indicator group, i.e., the optimal indicator system, because the default identification ability Fᵢ(M+1−i) of the indicator system is maximum.

Among all the indicator groups formed in the above 10 steps, the indicator group with the maximum Fisher Score value of the credit score is the optimal indicator group to ensure that the final indicator group can distinguish default customers and non-default customers to the maximum extent.

The present invention has the following advantageous effects that:

1. The present invention provides a method for optimizing a credit rating indicator group based on the maximum default identification ability measured by Fisher Score, which can ensure that the overall default identification ability of the credit rating system is maximum and open up an idea for constructing the credit rating indicator system.

2. n indicators can constitute 2ⁿ−1 indicator groups, and how to find the indicator group with the maximum default identification ability from a large number of indicator groups is a problem to be urgently solved in construction of the credit rating indicator system. The present invention solves the above problem with the idea of using the maximum default identification ability measured by Fisher Score of the credit score as the standard for optimizing an indicator group, comparing the Fisher Score values of the credit scores of different indicator groups formed by the traversing method, and selecting the indicator group with the maximum Fisher Score value of the credit score to form the indicator system.

3. The present invention provides reference for investors such as banks and individuals to make investment decisions. The method for selecting an optimal indicator group of the patent can be applied to banks and other financial institutions, and provides decision-making reference for banks to issue loans, enterprises to price bonds, guarantee companies to make credit guarantees, and individuals to make investment by establishing a credit risk evaluation indicator system with the maximum default identification ability measured by Fisher Score.

### DESCRIPTION OF DRAWINGS

FIG. 1 is a flow chart of the method for optimizing a credit rating indicator group based on the maximum default identification ability measured by Fisher Score.

FIG. 2 is a distribution diagram of a corresponding relation between the number of indicators and the Fisher Score values of the rating system.

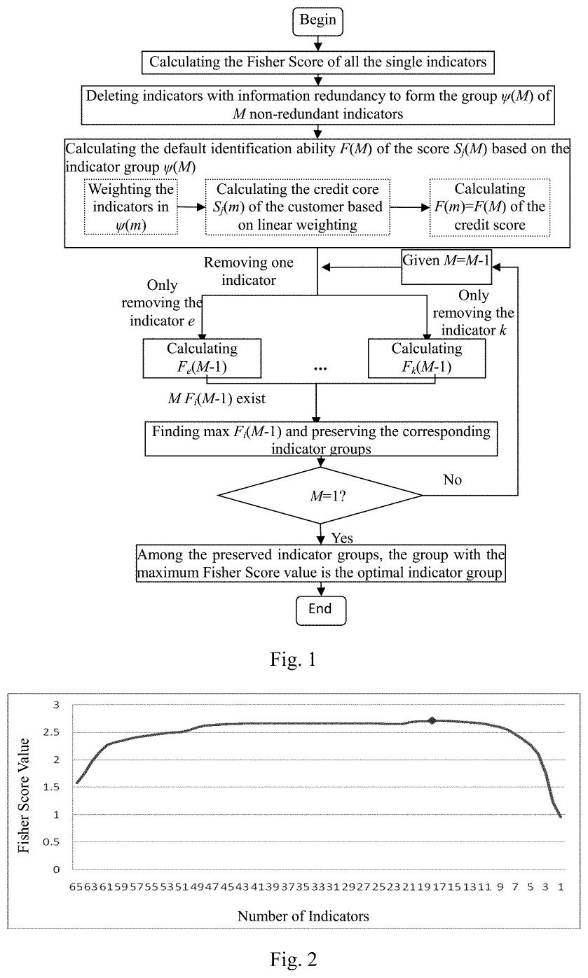

In FIG. 2, an ordinate is the Fisher Score value of the indicator group, and an abscissa is the number of indicators in different indicator groups formed by the method of the present invention; as the number of the indicators decreases, the Fisher Score value of the default identification ability of the rating system increases at first and then decreases; and the highest point is the point where the Fisher Score value is maximum.

### DETAILED DESCRIPTION

Specific embodiment of the present invention is further described below in combination with accompanying drawings and the technical solution.

The present invention provides a work flow of a method for optimizing a credit rating indicator group based on the maximum default identification ability measured by Fisher Score.

With the idea that the lower the intra-group dispersion degree of credit scores of default customers and non-default customers is, the higher the inter-group dispersion degree is, and the more the credit score can distinguish default customers from non-default customers, the Fisher Score value is used to measure the default identification ability of the credit score. The maximum default identification ability measured by Fisher Score of the credit score is used as the standard for optimizing an indicator group. After the indicators reflecting information redundancy are removed, the Fisher Score values of the credit scores of different indicator groups formed are compared by the traversing method, and the indicator group with the maximum Fisher Score value of the credit score is selected to form the indicator system.

The solution of the present invention has the following steps:

The steps of the solution in the present invention are described with the empirical sample of 3045 small business loans of a commercial bank in China in the past 20 years.

Step 1: loading data

Loading the source data of all the n=3045 samples, 81 mass-selection credit rating indicators and default status (default=1, non-default=0) indicators into an Excel file.

The first 81 indicators in column b of Table 1 are mass-selection observable indicators. Column c of Table 1 is the type of an indicator. Rows 1 to 81 in column d of Table 1 are the raw values of credit rating indicators, and row 82 is the value of a default status.

Step 2: preprocessing the data

Standardizing the raw data of the mass-selection credit rating indicators in the first 81 rows in column d of Table 1 by the Max-Min standardization method to eliminate the influence of indicator dimension.

Rows 1 to 81 in column e of Table 1 are the standardized values of the 81 indicators.

TABLE 1
Raw Data and Standardized Data of 81 Mass-Selection Credit Rating Indicators

| | | | (d) Raw Data Vᵢⱼ of Indicator | | | (e) Standardized Data Xᵢⱼ of Indicator | | |
|---|---|---|---|---|---|---|---|---|
| | | (c) | | | (3045) | (3046) | | (6090) |
| (a) | | Indicator | (1) Customer | | Customer | Customer | | Customer |
| No. | (b) Indicator | Type | 1 | . . . | 3045 | 1 | . . . | 3045 |
| 1 | Asset-Liability | Negative | 0.773 | . . . | 0.556 | 0.186 | . . . | 0.419 |
| | Ratio | | | | | | | |
| . . . | . . . | . . . | . . . | . . . | . . . | . . . | . . . | . . . |
| 48 | Retained Earnings | Positive | −0.159 | . . . | 1.251 | 0.509 | . . . | 0.518 |
| | Growth Rate | | | | | | | |
| . . . | . . . | . . . | . . . | . . . | . . . | . . . | . . . | . . . |
| 81 | Score of Mortgage | Qualitative | Mortgage on | . . . | No | 0.35 | . . . | 0.1 |
| | and Pledge | | Spot House of | | Mortgage | | | |
| | Guarantee | | Self-built | | or Pledge | | | |
| | | | Office | | | | | |
| | | | Building | | | | | |
| 82 | Default Status | — | 1 | . . . | 0 | 1 | . . . | 0 |

Step 3: calculating the default identification ability Fᵢ of single indicator

Measuring the default identification ability of the indicator by Fisher Score. The larger the Fisher Score value of the indicator is, the lower the intra-group numerical dispersion degree of default customers and non-default customers is, the higher the inter-group dispersion degree is, and the more the indicator can significantly distinguish the default customers from the non-default customers. The formula of the Fisher Score of the indicator xᵢ is as follows:

$${F}_{i} = \frac{{( {\overline{x}}_{i}^{( 0 )} - \overline{{x}_{i}} )}^{2} + {( {\overline{x}}_{i}^{( 1 )} - \overline{{x}_{i}} )}^{2}}{\frac{1}{{n}_{0}} {\sum }_{{ }^{j = 1}}^{{n}_{0}} {( {x}_{ij}^{( 0 )} - {\overline{x}}_{i}^{( 0 )} )}^{2} + \frac{1}{{n}_{1}} {\sum }_{h = 1}^{{n}_{1}} {( {x}_{ih}^{( 1 )} - {\overline{x}}_{i}^{( 1 )} )}^{2}} \qquad ( 1 )$$

In formula (1), Fᵢ is the Fisher Score value of the i^{th} indicator, wherein i=1, 2, . . . ; xᵢ⁻⁽⁰⁾ is the average value of non-default customers under the i^{th} indicator; xᵢ⁻⁽⁰⁾ is the average value of default customers under the i^{th} indicator; x̅ᵢ is the average value of customers under the i^{th} indicator; xᵢⱼ⁽⁰⁾ is the value of the j^{th} non-default customer under the i^{th} indicator; xᵢₕ⁽¹⁾ is the value of the h^{th} default customer under the i^{th} indicator; n₀ is the number of non-default customers; and n₁ is the number of default customers.

Substituting the data of each indicator in column e of Table 1 into formula (1) to obtain the Fisher Score value of each indicator.

Step 4: deleting the indicators reflecting information redundancy to form the first indicator group ψ₁(M)

Determining the indicator pair reflecting information redundancy in the 81 mass-selection indicators in column b of Table 1 through correlation analysis, deleting the indicator with the minimum Fisher Score value in the indicator pair reflecting information redundancy, and forming the first indicator group ψ₁(M)=ψ₁(65) by the remaining M=65 non-redundant indicators.

Several determination methods are provided to delete the indicators reflecting information redundancy.

Step 5: giving a weight wᵢ(m) to the credit rating indicator

Weighting the indicator by the formula

$${w}_{i} ( m ) = {F}_{i} / {\sum }_{i = 1}^{m} {F}_{i} ,$$

and ensuring that the larger the Fisher Score value of the indicator is, the larger the weight is.

Wherein wᵢ(m) is the weight of the i^{th} indicator in the indicator group ψ(m); and m is the number of indicators to be weighted in the indicator group ψ(m), wherein m=1, 2, . . . , M.

Step 6: calculating credit cores Sⱼ(m) of the customers

Solving the credit score of the customer j by the linear weighting formula

$${S}_{j} ( m ) = {\sum }_{i = 1}^{m} {w}_{i} ( m ) \times {x}_{ij} ,$$

wherein xᵢⱼ is the value of the j^{th} customer under the i^{th} indicator.

Step 7: calculating the default identification ability F₁(M) of the credit score Sⱼ(M) based on the indicator group ψ₁(M)

Substituting the credit score Sⱼ(m)=Sⱼ(M)=Sⱼ(65) of step 6 for the indicator xᵢ into formula (1) to obtain the default identification ability F₁(M)=F₁(65) of the credit score Sⱼ(65), i.e., the default identification ability F₁(65) of the indicator group ψ₁ (M)=ψ₁ (65).

This is different from step 3 in which the default identification ability measured by Fisher Score of single indicator is calculated, and step 7 to step 9 starting therefrom are to calculate the default identification ability measured by Fisher Score of the indicator group.

Step 8: determining the second indicator group ψ₂(M−1) and the default identification ability F₂(M−1) thereof

Removing one indicator on the basis of M=65 indicators of the first indicator group of step 4 to form the indicator groups ψ₂(M−1)=ψ₂(64) of M−1=65−1=64 indicators. The number of the groups ψ₂(M−1) is 65 because all the 1^{st} indicator, the 2^{nd} indicator and the 65^{th} indicator can be removed;

According to step 5 to step 7, testing the Fisher Score values F₂(64) of the 65 indicator groups ψ₂(64), and selecting the indicator group with the maximum Fisher Score and the maximum corresponding default identification ability measured by Fisher Score as the selection result of step 8 and the basis for next selection.

Step 9: determining other indicator groups and the default identification abilities thereof

Removing one indicator on the basis of the indicator group with the maximum Fisher Score obtained in step 8 to obtain the indicator groups ψf₃(M−2)=ψ₃(63) formed by M−2=63 indicators. This is similar to step 8 in that the number of the groups ψ₃(63) of the 63 indicators is 64 in total. According to step 8, testing the Fisher Score values F₃(63) of the 64 indicator groups ψ₃(63) to obtain the indicator group with the maximum Fisher Score and the maximum corresponding default identification ability measured by Fisher Score.

F₄(62), F₅(61), . . . , F₆₅(1) are obtained in the same manner.

Step 10: determining the optimal indicator group

In step 4 to step 9, selecting the indicator group ψᵢ(M+1−i) corresponding to the maximum value Fᵢ(M+1−i) from F₁(65), F₂(64), F₃(63), . . . , F₆₅(1) as the optimal indicator group, i.e., the optimal indicator system, because the default identification ability Fᵢ(M+1−i) of the indicator system is maximum.

Among all the indicator groups formed in the above 10 steps, the indicator group with the maximum Fisher Score value of the default identification ability of the credit score is the optimal indicator group to ensure that the final indicator group can distinguish default customers and non-default customers to the maximum extent.

The optimal credit rating indicator group including 18 indicators, as shown in column 2 of Table 2, is obtained by the method for determining an optimal indicator group of the present invention with the samples of 3045 small business loans of a commercial bank in China in the past 20 years, and the Fisher Score value of the indicator group is 2.714.

TABLE 2
Optimal Indicator Group and Comparison Indicator Group Thereof

| | | | |
|---|---|---|---|
| (1) | (2) Optimal Indicator | (3) Indicator Group | (4) Indicator Group |
| No. | Group Including 18 | Composed of First 18 | Composed of 18 |
| | Indicators Established | Indicators with the | Popular Indicators |
| | by the Patent | Maximum Fisher Score | |
| 1 | Current Debt Ratio of | Urban Per Capita | Current Ratio |
| | Earnings Before | Disposable Income | |
| | Interest and Tax | | |
| 2 | Full Capitalization | Credit Status | Asset-Liability |
| | Rate | of Enterprise in | Ratio |
| | | the Past Three Years | |
| . . . | . . . | . . . | . . . |
| 17 | Urban Per Capita | Capital Immobilized | Corporate Loan |
| | Disposable Income | Ratio | Default Record |
| 18 | Score of Mortgage | Total Assets | Type of Registered |
| | and Pledge | Growth Rate | Funds Available |

Column 3 of Table 2 is the indicator group composed of first 18 indicators with the maximum Fisher Score value among all the non-redundant indicators. The Fisher Score value of the credit score based on the indicator group is 1.570, which is significantly less than the Fisher Score value of 2.714 of the indicator group constructed on the basis of the method of the patent, indicating that the indicator group composed of single indicators with strong default identification ability does not necessarily have strong default identification ability.

Column 4 of Table 2 is the indicator group composed of high-frequency indicators teased out by looking up literature. The Fisher Score value of the credit score based on the indicator group is 0.673, which is significantly less than the Fisher Score value of 2.714 of the indicator group constructed on the basis of the patent, indicating that the indicator group composed of single indicators appearing to be popular does not necessarily have strong default identification ability.

FIG. 2 is drawn with the number of indicators in different indicator groups preserved in the process of selecting the optimal indicator in the patent as the abscissa and with the Fisher Score value of the indicator group as the ordinate. It is seen from FIG. 2 that as the number of the indicators in the indicator group decreases, the Fisher Score value of the default identification ability of the indicator group increases at first and then decreases, so for the rating indicator system, it is not that more or less indicators mean the better.

The present invention still has many embodiments. All the technical solutions formed by adopting equivalent replacement or equivalent transformation of “the method for optimizing credit rating indicator group based on the maximum default identification ability measured by Fisher Score” of the present invention fall within the protection scope of the present invention.

1. A method for optimizing a credit rating index group based on the maximum default identification ability measured by Fisher Score comprising the following steps:
step 1: loading data
loading the source data of n samples for credit rating, mass-selection credit rating indicators and default status into an Excel file, wherein the default status is divided into default=1 and non-default=0;
step 2: preprocessing the data
standardizing the source data of the mass-selection credit rating indicators by the Max-Min standardization method to eliminate the influence of indicator dimension;
step 3: calculating the default identification ability Fᵢ of single mass-selection credit rating indicator
measuring the default identification ability of the indicator by the Fisher Score; the larger the Fisher Score value of the indicator is, the lower the intra-group numerical dispersion degree of default customers and non-default customers is, the higher the inter-group dispersion degree is, and the more the indicator can significantly distinguish the default customers from the non-default customers; and the formula of the Fisher Score value of the indicator xᵢ is as follows:
$${F}_{i} = \frac{{( {\overline{x}}_{i}^{( 0 )} - \overline{{x}_{i}} )}^{2} + {( {\overline{x}}_{i}^{( 1 )} - \overline{{x}_{i}} )}^{2}}{\frac{1}{{n}_{0}} {\sum }_{{ }^{j = 1}}^{{n}_{0}} {( {x}_{ij}^{( 0 )} - {\overline{x}}_{i}^{( 0 )} )}^{2} + \frac{1}{{n}_{1}} {\sum }_{h = 1}^{{n}_{1}} {( {x}_{ih}^{( 1 )} - {\overline{x}}_{i}^{( 1 )} )}^{2}} \qquad ( 1 )$$
in formula (1), Fᵢ is the Fisher Score value of the i^{th} indicator, wherein i=1, 2, . . . ; xᵢ⁻⁽⁰⁾ is the average value of non-default customers under the i^{th} indicator; xᵢ⁻⁽¹⁾ is the average value of default customers under the i^{th} indicator; x̅ᵢ is the average value of customers under the i^{th} indicator; xᵢⱼ⁽⁰⁾ is the value of the j^{th} non-default customer under the i^{th} indicator; xᵢₕ⁽¹⁾ is the value of the h^{th} default customer under the i^{th} indicator; n₀ is the number of non-default customers; and n₁ is the number of default customers;
step 4: deleting the indicators reflecting information redundancy to form the first indicator group ψ₁(M)
determining the indicator pair reflecting information redundancy through correlation analysis, deleting the indicator with the minimum Fisher Score value in the indicator pair reflecting information redundancy, and forming the first indicator group ψ₁(M) by the remaining M non-redundant indicators;
step 5: giving a weight wᵢ(m) to the credit rating indicator
weighting the indicator by the formula
$${w}_{i} ( m ) = {F}_{i} / {\sum }_{i = 1}^{m} {F}_{i} ,$$
and ensuring that the larger the Fisher Score value of the indicator is, the larger the weight is;
wherein wᵢ(m) is the weight of the i^{th} indicator in the indicator group ψ(m); and m is the number of indicators to be weighted in the indicator group ψ(m), wherein m=1, 2, . . . , M;
step 6: calculating credit cores Sⱼ(m) of the customers
solving the credit score of the customer j by the linear weighting formula
$${S}_{j} ( m ) = {\sum }_{i = 1}^{m} {w}_{i} ( m ) \times {x}_{ij} ,$$
wherein xᵢⱼ is the value of the j^{th} customer under the i^{th} indicator;
step 7: calculating the default identification ability F₁(M) of the credit score Sⱼ(M) of the customer based on the indicator group ψ₁(M)
substituting the credit score Sⱼ(m)=Sⱼ(M) of step 6 for the indicator data xᵢ into formula (1) to obtain the default identification ability F₁(M) of the credit score Sⱼ(M), i.e., the default identification ability F₁(M) of the indicator group ψ₁(M);
this is different from step 3 in which the default identification ability measured by Fisher Score of single indicator is calculated, and step 7 to step 9 starting therefrom are to calculate the default identification ability measured by Fisher Score of the indicator group;
step 8: determining the second indicator group ψ₂(M−1) and the default identification ability F₂(M−1) thereof
removing one indicator on the basis of M indicators of the first indicator group of step 4 to form the indicator groups ψ₂(M−1) of M−1 indicators; and the number of the indicator groups ψ₂(M−1) is M, and M removal methods are provided;
according to step 5 to step 7, testing the Fisher Score values F₂(M−1) of the M indicator groups ψ₂(M−1), and selecting the indicator group with the maximum Fisher Score and the maximum corresponding default identification ability measured by Fisher Score as the selection result of step 8 and the basis for next selection;
step 9: determining other indicator groups and the default identification abilities thereof
removing one indicator on the basis of the indicator group with the maximum Fisher Score selected in step 8 to obtain the indicator groups ψ₃(M−2) formed by M−2 indicators; this is similar to step 8 in that the number of the groups ψ₃(M−2) of M−2 indicators is M−1 in total; and according to step 8, testing the Fisher Score values F₃(M−2) of the M−1 indicator groups ψ₃(M−2) to obtain the indicator group with the maximum Fisher Score and the maximum corresponding default identification ability measured by Fisher Score;
F₄(M−3), F₅(M−4), . . . , F_{M}(1) are obtained in the same manner;
step 10: determining the optimal indicator group
in step 4 to step 9, selecting the indicator group ψᵢ(M+1−i) corresponding to the maximum value Fᵢ(M+1−i) from F₁(M), F₂(M−1), F₃ (M−2), . . . , F_{M}(1) as the optimal indicator group, i.e., the optimal indicator system.
